(19) United States
(12) Patent Application Publication
(10) Pub. No.: US 2026/0330243 A1
(43) Pub. Date: Oct. 22, 2026

(54) LEARNING METHOD AND SYSTEM BASED ON FEDERATED LEARNING AND COMPUTING DEVICE FOR PERFORMING THE SAME

(71) Applicant: FOUNDATION OF SOONGSIL UNIVERSITY-INDUSTRY COOPERATION, Seoul (KR)

(72) Inventors: MINHAE KWON, Seoul (KR); MIRU KIM, Seoul (KR); HEEWON PARK, Seoul (KR)

(21) Appl. No.: 19/267,902

(22) Filed: Jul. 14, 2025

(30) Foreign Application Priority Data
Apr. 21, 2025 (KR) 10-2025-0051898

(51) Int. Cl. G06N 3/098; G06N 3/045

(52) U.S. Cl. CPC G06N 3/098; G06N 3/045

(57) ABSTRACT

A learning method is performed in a local client that includes one or more processors and a memory storing one or more programs executed by the one or more processors and includes a local model including an individual neural network and a shared neural network. The learning method includes inputting local data into the individual neural network to generate a local latent vector, inputting the local latent vector into the shared neural network to calculate a loss value based on a difference between an output from the shared neural network and a correct answer value, back-propagating the calculated loss value to update parameter of the individual neural network and the shared neural network, and transmitting local learning information including the local latent vector, the loss value, and the updated parameter of the shared neural network to a server.

### CROSS-REFERENCE TO RELATED APPLICATION AND CLAIM OF PRIORITY

This application claims the benefit under 35 USC § 119(a) of Korean Patent Application No. 10-2025-0051898, filed on Apr. 21, 2025, in the Korean Intellectual Property Office, the entire disclosure of which is incorporated herein by reference for all purposes.

### BACKGROUND

### 1. Field

Embodiments of the present disclosure relate to a learning technique based on federated learning.

### 2. Description of Related Art

In federated learning, individual devices (i.e., local clients) may train a neural network model without exposing data collected by the individual devices by transmitting only parameters of their local models to a server and sharing the parameters, instead of directly transmitting raw data, thereby preventing the risk of exposing private information.

However, the existing federated learning has difficulty in generating an optimized local model that fits the data characteristics of each individual device. Therefore, a personalized federated learning method has been proposed that trains a global model by sharing only some of the parameters of the local model with the server and personalizes the local model using the unshared parameters.

However, this personalized federated learning has difficulty in training a high-performance, complex deep learning model due to the limited computational capabilities (i.e., hardware constraints) of each individual device, which may lower the learning quality of each individual device and limit the performance of the entire system.

In addition, after completion of the federated learning, a label distribution of data acquired by each individual device in an actual service environment may change. That is, the label distribution of the data during federated learning and the label distribution of the data in the actual service environment after the completion of federated learning may be different from each other. In this case, the local model of each individual device may not adapt to the changing data distribution, which may cause the performance of the local model to degrade over time.

Examples of related art may include Korean Registered Patent Publication No. 10-2624299 (2024 Jan. 15).

### SUMMARY

Embodiments of the present disclosure are intended to provide a learning method and system based on federated learning and a computing device for performing the same.

A learning method according to a disclosed embodiment is a learning method performed in a local client that includes one or more processors and a memory storing one or more programs executed by the one or more processors and includes a local model including an individual neural network and a shared neural network, the learning method including inputting local data into the individual neural network to generate a local latent vector, inputting the local latent vector into the shared neural network to calculate a loss value based on a difference between an output from the shared neural network and a correct answer value, back-propagating the calculated loss value to update parameters of the individual neural network and the shared neural network, and transmitting local learning information including the local latent vector, the loss value, and the updated parameter of the shared neural network to a server.

The learning method may further include receiving a federated global parameter generated by aggregating the updated parameter of the shared neural network of each local client from the server and updating the parameter of the shared neural network with the federated global parameter.

The learning method may include a post-training process for additionally training the local model in an actual usage environment, and the post-training process may include calculating a confidence score of the local model for local data acquired in the actual usage environment and determining whether to use an output result of the global model of the server in the post-training process based on the calculated confidence score.

The calculating of the confidence score may include inputting the acquired local data into the local model and calculating entropy of the local model based on a class-specific predicted probability output from the local model and calculating the confidence score of the local model based on the entropy of the local model.

The confidence score de of the local model for the acquired local data x_{i,n} may be calculated according to Equation below.

$$Confidence ( {x}_{i , n} ) = 1 - \frac{H ( {x}_{i , n} )}{max ( {\{ H ( {x}_{i , n} ) \}}_{n = 1}^{N} )} \qquad Equation$$

N: total number of local data

$$max ( {\{ H ( {x}_{i , n} ) \}}_{n = 1}^{N} ) :$$

maximum entropy of local model
H(x_{i,n}): entropy of local model for acquired local data

Determining of whether to use the output result of the global model of the server may include determining to perform post-training using the global model when the confidence score of the local model is less than a preset threshold value.

The learning method may further include, after the determining to perform the post-training, receiving a class-specific predicted probability value of the global model for the local latent vector from the server and calculating a first loss by a difference between the class-specific predicted probability value of the local model for the acquired local data and the class-specific predicted probability value of the global model.

The global model is pre-trained, and the server may input the local latent vector of the local learning information into the global model to output the class-specific predicted probability value, extract the loss value of the local learning information to generate a correct answer approximate value, and train the global model based on a difference between the output class-specific predicted probability value and the correct answer approximate value.

The learning method may further include checking whether a label exists in the acquired local data, when the label exists, calculating a second loss by a difference between the class-specific predicted probability value of the local model for the acquired local data and a probability value of an actual correct answer, and minimizing a sum of the first loss and the second loss.

The learning method may further include calculating a third loss that minimizes the entropy of the local model for the acquired local data when the label does not exist, and minimizing a sum of the first loss and the third loss.

A computing device according to a disclosed embodiment is a computing device that includes one or more processors and a memory storing one or more programs executed by the one or more processors and includes a local model including an individual neural network and a shared neural network, in which the one or more programs include an instruction for inputting local data into the individual neural network to generate a local latent vector, an instruction for inputting the local latent vector into the shared neural network to calculate a loss value based on a difference between an output from the shared neural network and a correct answer value, an instruction for back-propagating the calculated loss value to update parameters of the individual neural network and the shared neural network, and an instruction for transmitting local learning information including the local latent vector, the loss value, and the updated parameter of the shared neural network to a server.

A learning method according to another disclosed embodiment is a learning method performed in a local client that includes one or more processors, a memory storing one or more programs executed by the one or more processors, and a global model, and the learning method including receiving local learning information including a local latent vector, a loss value, and an updated parameter of the shared neural network generated during a training process of a local model composed of an individual neural network and a shared neural network from each local client including the local model, aggregating the updated parameter of the shared neural network to generate a federated global parameter, and transmitting the federated global parameter to each local client to update the parameter of the shared neural network with the federated global parameter.

The learning method may further include inputting the local latent vector of the local learning information into the global model to acquire a class-specific predicted probability value of the global model, extracting the loss value of the local learning information to generate a correct answer approximate value to be used for training the global model, and training the global model based on a difference between the class-specific predicted probability value of the global model and the correct answer approximate value.

The loss value may be a value by a cross entropy loss, the generating of the correct answer approximate value may include extracting a class-specific predicted probability value of the local model from the loss value and setting a correct answer approximate value by comparing the class-specific predicted probability value of the global model with the class-specific predicted probability value of the local model.

In the setting of the correct answer approximate value, a predicted probability value of a class whose predicted probability value is closest to the class-specific predicted probability value of the local model among the class-specific predicted probability values of the global model may be set as a correct answer approximate value.

The learning method may include receiving a local latent vector for local data acquired in an actual usage environment from the local client, inputting the received local latent vector into the trained global model to generate the class-specific predicted probability value of the global model and transmitting the class-specific predicted probability value of the global model to the local client.

A computing device according to another disclosed embodiment is a computing device that includes one or more processors and a memory storing one or more programs executed by the one or more processors, and a global model, in which the one or more programs include an instruction for receiving local learning information including a local latent vector, a loss value, and an updated parameter of the shared neural network generated during a training process of a local model composed of an individual neural network and a shared neural network from each local client including the local model, an instruction for aggregating the updated parameter of the shared neural network to generate a federated global parameter, and an instruction for transmitting the federated global parameter to each local client to update the parameter of the shared neural network with the federated global parameter.

A learning system according to a disclosed embodiment is a learning system including a plurality of local clients, each of which includes a local model including an individual neural network and a shared neural network, and a server that includes a global model, in which the local client is configured to input local data into the individual neural network to generate a local latent vector, input the local latent vector into the shared neural network to calculate a loss value based on a difference between an output from the shared neural network and a correct answer value, back-propagate the calculated loss value to update parameters of the individual neural network and the shared neural network, and transmit local learning information including the local latent vector, the loss value, and the updated parameter of the shared neural network to a server, and the server is configured to aggregate the updated parameters of the shared neural network to generate a federated global parameter and transmit the federated global parameter to each local client to update the parameter of the shared neural network with the federated global parameter.

### BRIEF DESCRIPTION OF THE DRAWINGS

FIG. 1 is a diagram showing a configuration of a learning system based on federated learning according to an embodiment of the present disclosure.

FIG. 2 is a flowchart for describing a federated learning process of a learning method according to an embodiment of the present disclosure.

FIG. 3 is a diagram schematically showing a state in which the local client 102 according to an embodiment of the present disclosure acquires local learning information.

FIG. 4 is a flowchart for describing a global learning process of a learning method according to an embodiment of the present disclosure.

FIG. 5 is a flowchart for describing a post-training process of a learning method according to an embodiment of the present disclosure.

FIG. 6 is a block diagram for describing a computing environment including a computing device suitable for use in exemplary embodiments.

### DETAILED DESCRIPTION

Hereinafter, specific embodiments of the present disclosure will be described with reference to the drawings. The following detailed description is provided to facilitate a comprehensive understanding of the methods, apparatuses, and/or systems described herein. However, this is only an example and the present disclosure is not limited thereto.

In describing embodiments of the present disclosure, if it is determined that a specific description of a related known function of the preset invention may unnecessarily obscure the gist of the present disclosure, the detailed description thereof will be omitted. The terms described below are terms defined in consideration of the functions in the present disclosure, and vary depending on the intention or custom of the user or operator. Therefore, the definition should be made based on the contents throughout this specification. The terminology used in the detailed description is for the purpose of describing embodiments of the present disclosure only and should not be construed as limiting. Unless expressly used otherwise, singular forms include plural forms. In this description, the terms “including” or “comprising” are intended to refer to certain features, numbers, steps, operations, elements, portions or combinations thereof, and should not be construed to exclude the presence or possibility of one or more other features, numbers, steps, operations, elements, portions or combinations thereof other than those described.

In addition, the terms first, second, etc. may be used to describe various components, but the components should not be limited by the terms. The terms may be used for the purpose of distinguishing one component from another component. For example, without departing from the scope of the present disclosure, a first component may be referred to as a second component, and similarly, a second component may also be referred to as a first component.

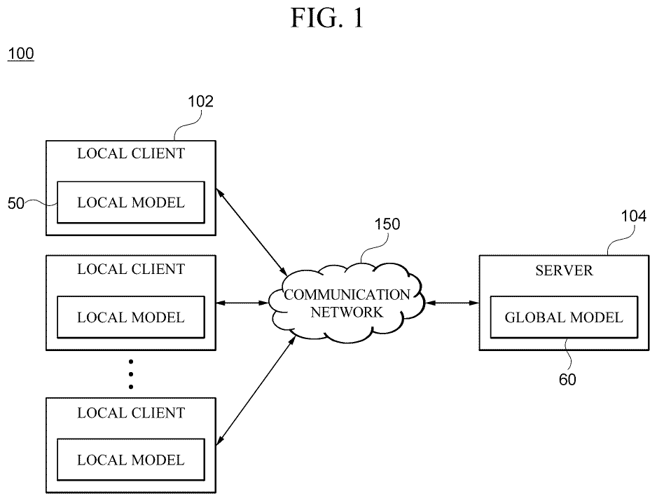

FIG. 1 is a diagram showing a configuration of a learning system based on federated learning according to an embodiment of the present disclosure.

Referring to FIG. 1, a learning system 100 may include a plurality of local clients 102 and a server 104. Each of the plurality of local clients 102 is communicatively connected to the server 104 through a communication network 150.

In an embodiment, the communication network 150 may include the Internet, one or more local area networks, wide area networks, cellular networks, mobile networks, other types of networks, or a combination of these networks.

Each local client 102 includes an artificial intelligence-based local model 50. Here, the local model 50 may include an individual neural network and a shared neural network. Here, parameters of the individual neural network are parameters that are not shared with the server 104, and parameters of the shared neural network are parameters that are shared with the server 104. An output layer of the individual neural network and an input layer of the shared neural network may be provided by being connected. In an embodiment, the individual neural network may be a neural network portion located in the first half of the entire neural network constituting the local model 50, and the shared neural network may be a neural network portion located in the second half of the entire neural network.

The server 104 includes an artificial intelligence-based global model 60. Here, the global model 60 may be a large-scale model having a larger neural network size than the local model 50.

Meanwhile, the server 104 may perform a federated learning process with a plurality of local clients 102 to update the parameters of the shared neural network of each local model 50. The server 104 may receive local learning information from each local client 102 and perform a global learning process of training the global model 60 based on the received local learning information.

In addition, each local client 102 may perform a post-training process according to a label distribution of local data in an actual online environment. In this case, the post-training process may be performed using the global model 60 trained in the global learning process. That is, the training of the global model 60 is to support post-training. Below, the federated learning process, the global learning process, and the post-training process will be described.

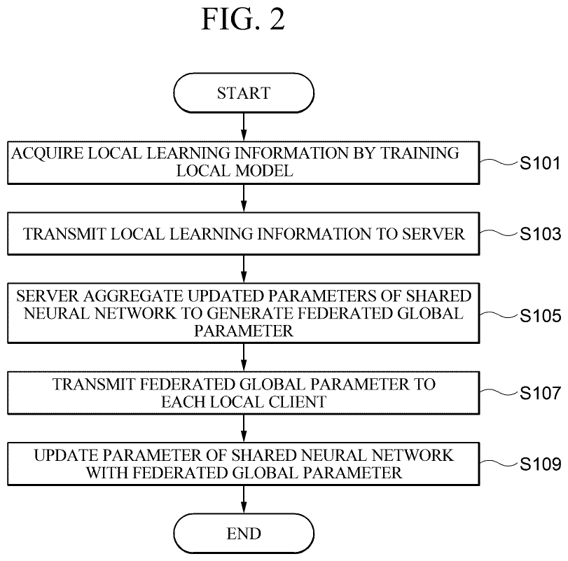

FIG. 2 is a flowchart for describing a federated learning process of a learning method according to an embodiment of the present disclosure. In the illustrated flowchart, the method may be described by being divided into multiple steps, but at least some of the steps may be performed in a different order, combined with other steps and performed together, omitted, divided into sub-steps and performed by adding one or more steps (not shown).

Referring to FIG. 2, the local client 102 may acquire local learning information by training the local model 50 with local data (S 101). The local client 102 may acquire local data and input the local data into the local model 50 to train the local model 50. The local client 102 may acquire local learning information in the process of training the local model 50.

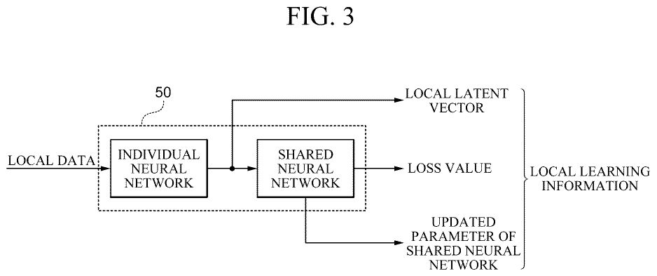

FIG. 3 is a diagram schematically showing a state in which the local client 102 according to an embodiment of the present disclosure acquires local learning information. Referring to FIG. 3, the local model 50 may include an individual neural network 51 and a shared neural network 53. The local client 102 may input local data into the individual neural network 51. The individual neural network 51 may generate a local latent vector from the local data.

The local latent vector may be input to the shared neural network 53. The local client 102 may calculate a loss value based on a difference between an output from the shared neural network 53 and a correct answer value and back-propagate the loss value to update the parameters of the local model 50 (i.e., the parameters of the shared neural network 53 and the parameters of the individual neural network 51).

Here, the local learning information may include the local latent vector output from the individual neural network 51, the loss value used for training the local model 50, and the updated parameters of the shared neural network 53.

Referring again to FIG. 2, the local client 102 may transmit the local learning information acquired in a training process of the local model 50 to the server 104 (S 103).

Next, the server 104 may extract the updated parameters of the shared neural network 53 from among the local learning information received from each local client 102, and aggregate the updated parameters of the extracted shared neural network 53 to generate a federated global parameter (S 105).

In an embodiment, the server 104 may generate the federated global parameter by calculating an average of the aggregated updated parameters of each shared neural network 53. The federated global parameter W̅ may be calculated according to Equation 1 below.

$$\overline{W} = \frac{1}{N} {\sum }_{i = 1}^{N} {W}_{i} \qquad Equation 1$$

N: total number of local clients
Wᵢ: updated parameter of shared neural network of i-th local client

Next, the server 104 may transmit the federated global parameter to each local client 102 (S 107). Then, each local client 102 may update the parameter of the shared neural network 53 with the federated global parameter received from the server 104 (S 109). Each local client 102 may update the parameter of the shared neural network 53 by using the federated global parameter received from the server 104 as the parameter of the shared neural network 53. In this way, the parameter of the shared neural network 53 of the local model 50 are updated through the federated learning process.

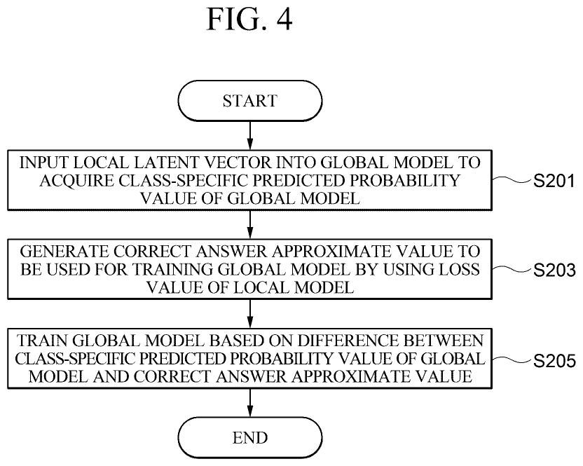

FIG. 4 is a flowchart for describing a global learning process of a learning method according to an embodiment of the present disclosure. In the illustrated flowchart, the method may be described by being divided into multiple steps, but at least some of the steps may be performed in a different order, combined with other steps and performed together, omitted, divided into sub-steps and performed by adding one or more steps (not shown).

Referring to FIG. 4, the server 104 may extract a local latent vector from among local learning information received from each local client 102, and inputs each extracted local latent vector into the global model 60 to acquire a class-specific predicted probability value of the global model 60 (S 201).

That is, in the global learning process, actual local data is not used, but the local latent vector, which is a kind of indirect information, may be used as input data of the global model 60. Thus, it is possible to prevent private data from being exposed.

Next, the server 104 may extract a loss value of the local model 50 from among the local learning information received from each local client 102 and generate a correct answer approximate value to be used for training the global model 60 (S 203).

That is, since an error between an output from the global model 60 and an actual correct answer value should be calculated for training the global model 60, an actual correct answer value is required, but, in the disclosed embodiment, an approximate correct answer of the global model 60 may be generated based on the loss value of the local model 50 in order to prevent the actual correct answer value from being exposed.

Specifically, the server 104 may calculate a class-specific predicted probability value of the local model 50 based on the loss value of the local model 50. In this case, the loss value of the local model 50 may be a cross entropy loss. For example, the loss value of the local model 50 may be expressed as the cross entropy loss of Equation 2 below.

$${l}_{i , n} = {\sum }_{c = 0}^{C} 𝕝 ( c ; {y}_{i , n} ) {log}_{m} Q ( c \vert {s}_{i} ◦ {p}_{i} ( {x}_{i , n} ) ) \qquad Equation 2$$

l_{i,n}: loss value for n-th local data of i-th local client
C: total number of classes
y_{i,n}: correct answer value for x_{i,n}
[symbol] (c;y_{i,n}): probability value of actual correct answer for class c
x_{i,n}: n-th local data of i-th local client
sᵢ: parameter of shared neural network of i-th local client
pᵢ: parameter of individual neural network of i-th local client
pᵢ(x_{i,n}): local latent vector of i-th client
Q(c|sᵢ∘pᵢ(x_{i,n})): predicted probability value of local model for class c

According to the cross entropy loss of Equation 2, the local model 50 may be trained to minimize a difference between a predicted probability output from the local model and a probability value of the actual correct answer.

Meanwhile, in Equation 2, for [symbol] (c;y_{i,n}), since the probability value of other classes except for the actual correct answer class is 0 and only the probability value of the actual correct answer class is 1, the loss value l_{i,n} for the actual correct answer class c may be expressed as logₘ Q(c|sᵢ∘pᵢ(x_{i,n})).

Here, the server 104 may remove a logarithmic value by applying an exponential function to the lost value l_{i,n} in order to take only the predicted probability value Q(c|sᵢ∘pᵢ(x_{i,n})) for the local model for class c. That is, the server 104 may extract a class-specific predicted probability output from the local model 50 from among the loss value of the local model 50.

The server 104 may compare the class-specific predicted probability value of the global model 60 obtained by inputting the local latent vector to the global model 60 with the class-specific predicted probability value of the local model 50 to set a predicted probability value of a class whose predicted probability value is closest thereto as a correct answer approximate value. That is, the server 104 may set the predicted probability value of the class whose predicted probability value is closest to the class-specific predicted probability value of the local model among the class-specific predicted probability values of the global model as the correct answer approximate value.

Next, the server 104 may train the global model 60 (i.e., update the parameter of the global model 60) based on the difference between the class-specific predicted probability value of the global model 60 and the correct answer approximate value (S 205).

In this way, in the global learning process, the global model 60 may be trained using indirect information (i.e., the local latent vector and the loss value) acquired from the local model 50. In this case, the training of the global model 60 may be performed only with the indirect information without exposing the local data

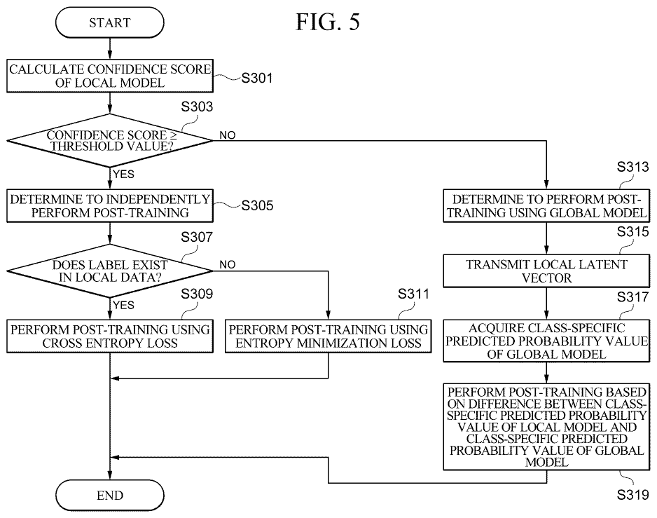

FIG. 5 is a flowchart for describing a post-training process of a learning method according to an embodiment of the present disclosure. In the illustrated flowchart, the method may be described by being divided into multiple steps, but at least some of the steps may be performed in a different order, combined with other steps and performed together, omitted, divided into sub-steps and performed by adding one or more steps (not shown). Here, the post-training means that the local client 102 additionally trains the local model 50 in an actual usage environment (i.e., an application environment). In the post-training, only the parameters of the individual neural network of the local model 50 are trained, and the parameters of the shared neural network may be fixed.

Referring to FIG. 5, when the local client 102 acquires local data in the actual usage environment, the local client 102 may calculate a confidence score of the local model 50 for the acquired local data (S 301).

Specifically, the local client 102 may input the acquired local data into the local model 50 and calculate entropy of the local model 50 based on a class-specific probability distribution output from the local model 50. Here, when the local client 102 is an i-th local client and the acquired local data is n-th data, the entropy H(x_{i,n}) of the local model 50 may be expressed according to Equation 3 below.

$$H ( {x}_{i , n} ) = {\sum }_{c = 1}^{C} Q ( c \vert {s}_{i} ◦ {p}_{i} ( {x}_{i , n} ) ) log Q ( c \vert {s}_{i} ◦ {p}_{i} ( {x}_{i , n} ) ) \qquad Equation 3$$

C: total number of classes
Q(c|sᵢ∘pᵢ(x_{i,n})): predicted probability value of local model for class c

Since the technique of obtaining the entropy of an artificial neural network model is already known, a detailed description thereof will be omitted. Here, since the entropy and the confidence score of the local model 50 have an inverse relationship, the confidence score of the local model 50 can be calculated by obtaining the entropy of the local model 50.

In an embodiment, the local client 102 may calculate the confidence score of the local model 50 based on the entropy of the local model 50 for the acquired local data x_{i,n} and the maximum entropy of the local model 50. The maximum entropy of the local model 50 is a value having the highest entropy when each data set is input to the local model 50. The local client 102 may calculate the confidence score of the local model 50 for the acquired local data x_{i,n} acquired according to Equation 4 below.

$$Confidence ( {x}_{i , n} ) = 1 - \frac{H ( {x}_{i , n} )}{max ( {\{ H ( {x}_{i , n} ) \}}_{n = 1}^{N} )} \qquad Equation 4$$

N: total number of local data

$$max ( {\{ H ( {x}_{i . n} ) \}}_{n = 1}^{N} ) :$$

maximum entropy of local model
Next, the local client 102 may check whether the confidence score of the local model 50 is greater than or equal to a preset threshold value (S 303).

As a result of checking S 303, when the confidence score of the local model 50 is greater than or equal to the preset threshold value, the local client 102 may determine to independently perform post-training for the local model 50 by the local client 102 (S 305).

That is, if the confidence score of the local model 50 is greater than or equal to the preset threshold value, the local client 102 may determine to independently perform post-training without the help of the server 104.

Next, the local client 102 may check whether a label exists in the acquired local data (S 307).

As a result of checking S 307, when the label exists in the acquired local data, the local client 102 may perform post-training on the local model 50 based on the difference between the class-specific predicted probability value of the local model 50 for the acquired local data and the probability value of the actual correct answer by the label (S 309). That is, the local client 102 may perform post-training on the local model 50 using a cross entropy loss L_{CE} of Equation 5 below.

$${L}_{CE} = {\sum }_{c = 0}^{C} 𝕝 ( c : {y}_{i , n} ) {log}_{m} Q ( c \vert {s}_{i} ◦ {p}_{i} ( {x}_{i , n} ) ) \qquad Equation 5$$

As a result of checking S 307, when the label does not exist in the acquired local data, the local client 102 may perform post-training on the local model 50 to minimize the entropy of the local model 50 for the acquired local data (S 311). That is, when the label does not exist in the acquired local data, the post-training of the local model 50 may be performed using a loss function of minimizing the entropy of the local model 50 for the acquired local data. In this case, an entropy minimization loss L_{EM} can be expressed according to Equation 6 below.

$$Equation 6$$

$${L}_{EM} = H ( {x}_{i , n} ) = {\sum }_{c = 1}^{C} Q ( c \vert {s}_{i} ◦ {p}_{i} ( {x}_{i , n} ) ) log Q ( c \vert {s}_{i} ◦ {p}_{i} ( {x}_{i , n} ) )$$

As a result of checking S 303, when the confidence score of the local model 50 is less than the preset threshold value, the local client 102 may determine to perform post-training on the local model 50 using the global model 60 of the server 104 (S 313).

In S 313, when it is determined that the post-training on the local model 50 is performed using the global model 60 of the server 104, the local client 102 may transmit the local latent vector for the acquired local data to the server 104 (S 315). That is, the local client 102 may input the acquired local data into an individual neural network to generate a local latent vector, and transmit the generated local latent vector to the server 104.

Next, the local client 102 may acquire a class-specific predicted probability values of the global model 60 for the local latent vector from the server 104 (S 317). In this case, the server 104 may input the local latent vector of the local learning information into the global model 60 to generate the class-specific predicted probability value of the global model 60 and transmit the class-specific predicted probability value to the local client 102.

Next, the local client 102 may perform post-training on the local model 50 based on the difference between the class-specific predicted probability value of the local model 50 for the local data and the class-specific predicted probability value of the global model 60 (S 319).

In an embodiment, the local client 102 may perform post-training on the local model 50 using a KL-Divergence loss L_{KL} according to Equation 7.

$${L}_{KL} = {\sum }_{c = 0}^{C} Q ( c \vert G ◦ {p}_{i} ( {x}_{i , n} ) ) {log}_{m} \frac{Q ( c \vert G ◦ {p}_{i} ( {x}_{i , n} ) )}{Q ( c \vert \overline{s} ◦ {p}_{i} ( {x}_{i , n} ) )} \qquad ( Equation 7 )$$

G: parameter of global model
Q(c|G∘pᵢ(x_{i,n})): class-specific predicted probability value of global model
Q(c|s̅∘pᵢ(x_{i,n})): class-specific predicted probability value of local model
s̅: updated parameter of shared neural network of local model (federated global parameter)

Meanwhile, when performing post-training using the global model 60 of the server 104, the post-training may be performed on the local model 50 by using the class-specific predicted probability value of the local model 50 for the local data together. In this case, if a label exists in the local data, post-training may be performed by an overall loss function Lₒₙₗᵢₙₑ according to Equation 8.

Lₒₙₗᵢₙₑ=λL_{CE}+(1−λ)L_{KL} (Equation 8)
L_{CE}: cross entropy loss
L_{KL}: KL-Divergence loss
λ: weight between cross entropy loss and KL-Divergence loss

Here, L_{CE} may be the cross entropy loss according to Equation 5, and L_{KL} may be the KL-Divergence loss according to Equation 7.

In addition, if the label does not exist in the local data, post-training may be performed by the overall loss function Lₒₙₗᵢₙₑ according to Equation 9.

Lₒₙₗᵢₙₑ=λL_{EM}+(1−λ)L_{KL} Equation 9
L_{EM}: entropy minimization loss
L_{KL}: KL-Divergence loss
λ: weight between entropy minimization loss and KL-Divergence loss

Here, L_{EM} is the cross entropy loss according to Equation 6, and L_{KL} may be the KL-Divergence loss according to Equation 7.

According to the disclosed embodiment, by training the global model 60 of the server 104 to be used for post-training as well as the federated learning between local clients in pre-training, the local model 50 can be continuously trained using the global model 60, which is a high-performance model, even in a situation where the label distribution of local data changes in an actual service environment.

In addition, by using the local latent vector and loss value, which are indirect information of the local model 50, when training the global model 60 of the server 104, it is possible to protect personal information by preventing private data from being exposed to the outside.

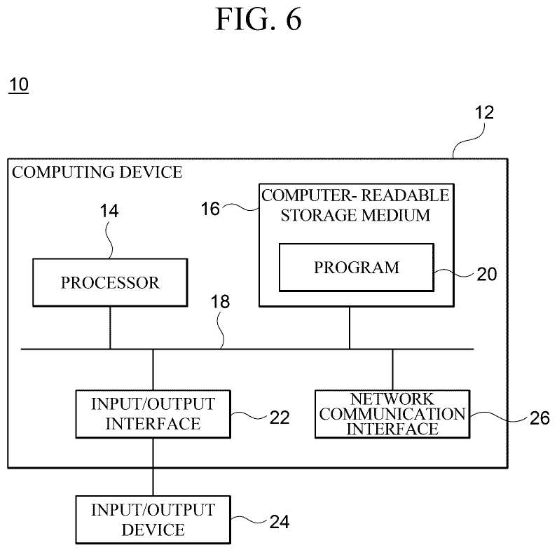

FIG. 6 is a block diagram illustrating a computing environment 10 including a computing device suitable for use in exemplary embodiments. In the illustrated embodiment, respective components may have different functions and capabilities other than those described below, and include additional components in addition to those described below.

The illustrated computing environment 10 includes a computing device 12. In an embodiment, the computing device 12 may be a local client 102. In addition, the computing device 12 may be a server 104.

The computing device 12 includes at least one processor 14, a computer-readable storage medium 16, and a communication bus 18. The processor 14 may cause the computing device 12 to operate according to the exemplary embodiment described above. For example, the processor 14 may execute one or more programs stored on the computer-readable storage medium 16. The one or more programs may include one or more computer-executable instructions, which, when executed by the processor 14, may be configured so that the computing device 12 performs operations according to the exemplary embodiment.

The computer-readable storage medium 16 is configured to store the computer-executable instruction or program code, program data, and/or other suitable forms of information. A program 20 stored in the computer-readable storage medium 16 includes a set of instructions executable by the processor 14. In an embodiment, the computer-readable storage medium 16 may be a memory (volatile memory such as a random access memory, non-volatile memory, or any suitable combination thereof), one or more magnetic disk storage devices, optical disk storage devices, flash memory devices, other types of storage media that are accessible by the computing device 12 and capable of storing desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 through the input/output interface 22. The exemplary input/output device 24 may include a pointing device (such as a mouse or trackpad), a keyboard, a touch input device (such as a touch pad or touch screen), a speech or sound input device, input devices such as various types of sensor devices and/or photographing devices, and/or output devices such as a display device, a printer, a speaker, and/or a network card. The exemplary input/output device 24 may be included inside the computing device 12 as a component configuring the computing device 12, or may be connected to the computing device 12 as a separate device distinct from the computing device 12.

According to the disclosed embodiment, by training the global model of the server to be used for post-training as well as the federated learning between local clients in pre-training, the local model 50 can be continuously trained using the global model, which is a high-performance model, even in a situation where the label distribution of local data changes in an actual service environment.

In addition, by using the local latent vector and loss value, which are indirect information of the local model, when training the global model of the server, it is possible to protect personal information by preventing private data from being exposed to the outside.

Although representative embodiments of the present disclosure have been described in detail above, those skilled in the art will understand that various modifications may be made to the above-described embodiments without departing from the scope of the present disclosure. Therefore, the scope of the present disclosure should not be limited to the described embodiments, but should be defined not only by the patent claims described below but also by those equivalent to the patent claims.

What is claimed is:

1. A learning method performed in a local client that includes one or more processors and a memory storing one or more programs executed by the one or more processors and includes a local model including an individual neural network and a shared neural network, the learning method comprising:
inputting local data into the individual neural network to generate a local latent vector;
inputting the local latent vector into the shared neural network to calculate a loss value based on a difference between an output from the shared neural network and a correct answer value;
back-propagating the calculated loss value to update parameters of the individual neural network and the shared neural network; and
transmitting local learning information including the local latent vector, the loss value, and the updated parameter of the shared neural network to a server.

2. The learning method of claim 1, further comprising:
receiving a federated global parameter generated by aggregating the updated parameter of the shared neural network of each local client from the server; and
updating the parameter of the shared neural network with the federated global parameter.

3. The learning method of claim 2, wherein the learning method includes a post-training process for additionally training the local model in an actual usage environment, and
the post-training process includes:
calculating a confidence score of the local model for local data acquired in the actual usage environment; and
determining whether to use an output result of the global model of the server in the post-training process based on the calculated confidence score.

4. The learning method of claim 3, wherein the calculating of the confidence score includes:
inputting the acquired local data into the local model and calculating entropy of the local model based on a class-specific predicted probability output from the local model; and
calculating the confidence score of the local model based on the entropy of the local model.

5. The learning method of claim 4, wherein the confidence score Confidence(x_{i,n}) of the local model for the acquired local data x_{i,n} is calculated according to Equation below,
$$Confidence ( {x}_{i , n} ) = 1 - \frac{H ( {x}_{i ,} )}{max ( {\{ H ( {x}_{i , n} ) \}}_{n = 1}^{N} )} \qquad Equation 6$$
N: total number of local data
$$max ( {\{ H ( {x}_{i , n} ) \}}_{n = 1}^{N} ) :$$
maximum entropy of local model
H(x_{i,n}): entropy of local model for acquired local data.

6. The learning method of claim 4, wherein the determining of whether to use the output result of the global model of the server includes determining to perform post-training using the global model when the confidence score of the local model is less than a preset threshold value.

7. The learning method of claim 6, further comprising:
after the determining to perform the post-training,
receiving a class-specific predicted probability value of the global model for the local latent vector from the server; and
calculating a first loss by a difference between the class-specific predicted probability value of the local model for the acquired local data and the class-specific predicted probability value of the global model.

8. The learning method of claim 7, wherein the global model is pre-trained, and
the server inputs the local latent vector of the local learning information into the global model to output the class-specific predicted probability value, extracts the loss value of the local learning information to generate a correct answer approximate value, and trains the global model based on a difference between the output class-specific predicted probability value and the correct answer approximate value.

9. The learning method of claim 7, further comprising:
checking whether a label exists in the acquired local data;
when the label exists, calculating a second loss by a difference between the class-specific predicted probability value of the local model for the acquired local data and a probability value of an actual correct answer; and
minimizing a sum of the first loss and the second loss.

10. The learning method of claim 9, further comprising:
calculating a third loss that minimizes the entropy of the local model for the acquired local data when the label does not exist; and
minimizing a sum of the first loss and the third loss.

11. A learning method performed in a local client that includes one or more processors, a memory storing one or more programs executed by the one or more processors, and a global model, the learning method comprising:
receiving local learning information including a local latent vector, a loss value, and an updated parameter of the shared neural network generated during a training process of a local model composed of an individual neural network and a shared neural network from each local client including the local model;
aggregating the updated parameter of the shared neural network to generate a federated global parameter; and
transmitting the federated global parameter to each local client to update the parameter of the shared neural network with the federated global parameter.

12. The learning method of claim 11, further comprising:
inputting the local latent vector of the local learning information into the global model to acquire a class-specific predicted probability value of the global model;
extracting the loss value of the local learning information to generate a correct answer approximate value to be used for training the global model; and
training the global model based on a difference between the class-specific predicted probability value of the global model and the correct answer approximate value.

13. The learning method of claim 12, wherein the loss value is a value by a cross entropy loss, and
the generating of the correct answer approximate value further includes:
extracting a class-specific predicted probability value of the local model from the loss value; and
setting a correct answer approximate value by comparing the class-specific predicted probability value of the global model with the class-specific predicted probability value of the local model.

14. The learning method of claim 13, wherein, in the setting of the correct answer approximate value, a predicted probability value of a class whose predicted probability value is closest to the class-specific predicted probability value of the local model among the class-specific predicted probability values of the global model is set as a correct answer approximate value.

15. The learning method of claim 12, further comprising:
receiving a local latent vector for local data acquired in an actual usage environment from the local client;
inputting the received local latent vector into the trained global model to generate the class-specific predicted probability value of the global model; and
transmitting the class-specific predicted probability value of the global model to the local client.

16. A learning system comprising:
a plurality of local clients, each of which includes a local model including an individual neural network and a shared neural network; and
a server that includes a global model,
wherein the local client is configured to:
input local data into the individual neural network to generate a local latent vector;
input the local latent vector into the shared neural network to calculate a loss value based on a difference between an output from the shared neural network and a correct answer value;
back-propagate the calculated loss value to update parameters of the individual neural network and the shared neural network; and
transmit local learning information including the local latent vector, the loss value, and the updated parameter of the shared neural network to a server, and
the server is configured to:
aggregate the updated parameter of the shared neural network to generate a federated global parameter; and
transmit the federated global parameter to each local client to update the parameter of the shared neural network with the federated global parameter.
